(19) United States
(12) Patent Application Publication
(10) Pub. No.: US 2026/0218835 A1
(43) Pub. Date: Jul. 30, 2026

(54) BYPASSING A PORTION OF A PIPELINE

(71) Applicant: Saudi Arabian Oil Company, Dhahran (SA)

(72) Inventors: Tariq A. Khathami, Dammam (SA); Abdullah M. Salma, Dammam (SA); Abdulrahman E. Sayed, Dhahran (SA); Essa I. Alnaimi, Dhahran (SA); Christian M. Canto Maya, Dhahran (SA)

(21) Appl. No.: 19/038,189

(22) Filed: Jan. 27, 2025

(51) Int. Cl. F16L 55/16

(52) U.S. Cl. CPC F16L 55/1612; F16L 55/1604

(57) ABSTRACT

A system and method for bypassing a rupture in a pipeline with a magnet and a bypass assembly. The magnet is placed outside the pipeline proximal the rupture. The bypass assembly is positioned inside the pipeline. The bypass assembly has a hollow cylinder, an expansion tube disposed about and slidable relative to the hollow cylinder, expansion ring sub-assemblies which expand from the expansion tube from a stored position to an extended position responsive to the expansion tube sliding, and a ferromagnetic tail extending from the hollow cylinder. The ferromagnetic tail articulates to contact an inner surface of the pipeline responsive to the magnetic field of the magnet. The ferromagnetic tail contacting the inner surface of the pipeline directs a fluid flow to the expansion tube, moving the expansion tube from the first position to the second position and shifting the expansion ring sub-assemblies to the extended position.

### TECHNICAL FIELD

This disclosure relates to bypassing a portion of a pipeline, for example, with an internal bypass assembly.

### BACKGROUND

Pipelines are crucial conduits for transporting vital fluids such as water, CO₂, oil, and natural gas between locations. Sometimes, pipelines become damaged or develop a rupture causing a leak to the surrounding environment. Such incidents not only lead to environmental degradation through contamination of ecosystems and release of greenhouse gases, but also pose direct safety threats to humans, including the risk of suffocation from CO₂ leaks or fires and explosions from oil and gas related leaks. These events can have dire consequences on public health, safety, and the surrounding environment. Economically, the repercussions of a leak or rupture in a pipeline can include severe operational disruptions and heavy financial losses due to pipeline downtime and repair costs.

### SUMMARY

This disclosure relates to an approach to bypassing a portion of a pipeline. This approach uses a moveable bypass assembly to internally bypass a rupture in the pipeline. The moveable bypass assembly is moved through a pipeline by flow in the pipeline until it is actuated by a magnet placed near the rupture. The magnet magnetically fixes an upstream end of the bypass assembly in place in the pipeline while fluid flow continues to push a downstream end of the bypass assembly further downstream. The increasing distance between the two ends deploys a pair of expansion seal assemblies on either side of the rupture. The magnet is positioned outside the pipeline so that the expansion rings assemblies actuate with one expansion ring sub-assembly upstream of the rupture and another expansion ring sub-assembly downstream of the rupture. This positioning isolates the leak passing through the rupture so that fluid in the pipeline flows through an internal channel extending through the bypass assembly instead of through the rupture to the surrounding environment. This approach can isolate and bypass the rupture, providing for continued flow of the fluid in the pipeline past the leak in a safe manner. This approach can

enhance the overall safety of a plant having pipelines or pipelines between locations by bypassing the rupture location while the pipeline is repaired.

Implementations of the present disclosure can realize one or more of the following advantages. For example, this approach can reduce downtime required for pipeline repairs. By maintaining one or more bypass assemblies within the pipeline and ready for release and movement to a location of the rupture, the time to isolate a leak from the rupture can be reduced, so repairs can be started sooner.

This approach can also reduce pipeline operational disruptions. For example, fluid flow through the pipeline can be maintained without loss of fluid through the leaking portion by bypassing the portion of the pipeline having the rupture, instead of stopping flow in an entire section of pipeline and draining the pipeline.

Implementations of this present disclosure can also simplify repair operations performed on the ruptured pipeline. For example, repairs can be conducted while fluid continues to flow through the pipeline by bypassing the portion of the pipeline having the leak with the bypass assembly. The bypass assembly can conduct the fluid past the location of the leak without stopping flow in an entire section of pipeline and draining the pipeline.

This approach can improve public health and safety. For example, the time to isolate the leak can be reduce and less fluid is released from the leak by maintaining one or more bypass assemblies within the pipeline and ready for release and movement to a location of the leak. Some fluids can harm people. Reducing the quantity of fluid that can contact personnel in the vicinity of the leak can improve public health and safety. For example, worker safety can be improved by using robots to externally place the magnets near the rupture and internally conducting the bypass assembly within the pipeline to the location of the rupture.

This approach can improve environmental safety. For example, the time to isolate a leak can be reduced and less fluid is released from the leak by maintaining one or more bypass assemblies within the pipeline and ready for release and movement to a location of a leak. Some fluids can harm the environment. Reducing the quantity of fluid that enters the environment from the leak can improve environmental safety.

This approach can improve business continuity. When flow of oil and gas through the pipeline is secured for maintenance or repair, the oil and gas being conducted through the pipeline no longer reaches its intended destination such as a refinery, a processing facility, a transportation or shipping hub, or a customer location. This disrupts business operations. Continuing to flow oil and gas through the pipeline past the rupture, while still isolating the rupture, with the bypass assembly can provide business continuity.

This approach can reduce or minimize the cost losses related to the loss of product. For example, especially when one or more bypass assemblies are pre-positioned in the pipeline before the rupture occurs, the rupture can be isolated and the leak stopped quickly, reducing the amount of lost oil and gas products lost to the surrounding environment. When the pipeline is buried, even more time may be lost determining the exact location of the leak and excavating the earth surrounding the location of the rupture. Internally isolating the rupture with these bypass assemblies can reduce or minimize the lost product, and therefore also reduce or minimize the cost losses.

This approach can prevent the leak from getting worse. For example, when the rupture remains unisolated, the pressure or flow through the pipeline can cause the size or severity of the rupture to increase over time, increasing the quantity of leaking fluid exiting the pipeline into the surrounding environment. Using one or more of these bypass assemblies can keep the leak from getting worse.

### BRIEF DESCRIPTION OF DRAWINGS

FIG. 1 shows a perspective view of a bypass system for bypassing a portion of a pipeline.

FIG. 2 shows a perspective view of the bypass system of FIG. 1 with a bypass assembly actuated to bypass the portion of the pipeline.

FIG. 3 is rear view of the bypass system of FIG. 1 with the bypass assembly actuated to bypass the portion of the pipeline.

FIGS. 4A-4C are perspective views illustrating operation of an expansion ring sub-assembly of the bypass assembly of FIG. 1.

FIGS. 5A-5C are perspective views illustrating operation of an expansion member of the expansion ring sub-assembly of FIGS. 4A-4B.

FIG. 6 is a flow chart of an example method of bypassing a portion of a pipeline.

### DETAILED DESCRIPTION

This approach uses a moveable bypass assembly to internally bypass a rupture in a pipeline. Pipelines conduct fluids from one location to another location. Sometimes, pipelines can become damaged, causing a rupture in the pipeline allowing the fluids contained within the pipelines to leak out into the environment. When a leak occurs, the moveable bypass assembly is released into the pipeline and moved through at the pipeline by flow in the pipeline until it is actuated by a magnet placed near the leak. The magnet fixes an upstream end of the bypass assembly in place in the pipeline while fluid flow continues to push a downstream end of the bypass assembly further downstream with the increasing distance between the two ends deploying a pair of expansion seal assemblies on either side of the leak. The magnet is positioned outside the pipeline so that the expansion rings assemblies actuate with one expansion ring sub-assembly upstream of the leak and another expansion ring sub-assembly downstream of the leak. This positioning isolates the leak so that fluid in the pipeline flows through an internal channel extending through the bypass assembly. This approach internally seals the leaking portion of the pipeline and creates the internal channel through the pipeline bypassing the leaking portion to allow for continued operation of the pipeline.

The bypass assembly has a hollow cylinder, expansion rings, a ferromagnetic tail, and an expansion tube. The hollow cylinder has a channel to conduct fluid within the pipeline past the location of the leak. The expansion rings expand from the hollow cylinder from a stored position to an extended position to contact and seal against an inner surface of the pipeline upstream and downstream of the leak location. The ferromagnetic tail bends in the presence of the magnetic field to contact the inner surface of the pipeline. The expansion tube shifts the expansion rings between the stored position and the extended position.

The magnet can be placed near the location of the leak external to the pipeline and a bypass assembly that can be pre-positioned or introduced into the pipeline to internally seal and bypass the leaking portion of the pipeline. The magnet generates a magnetic field which holds the bypass assembly at the location of the rupture.

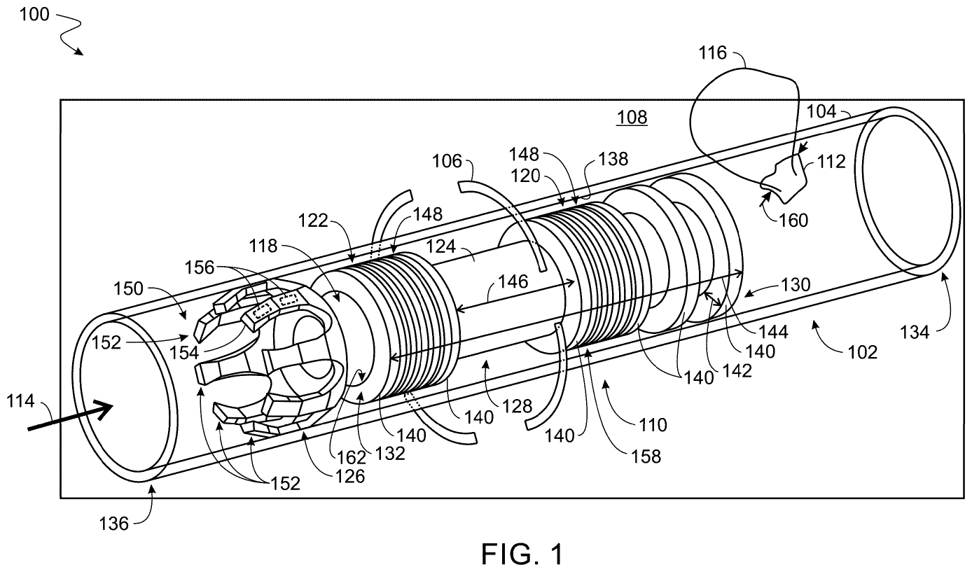

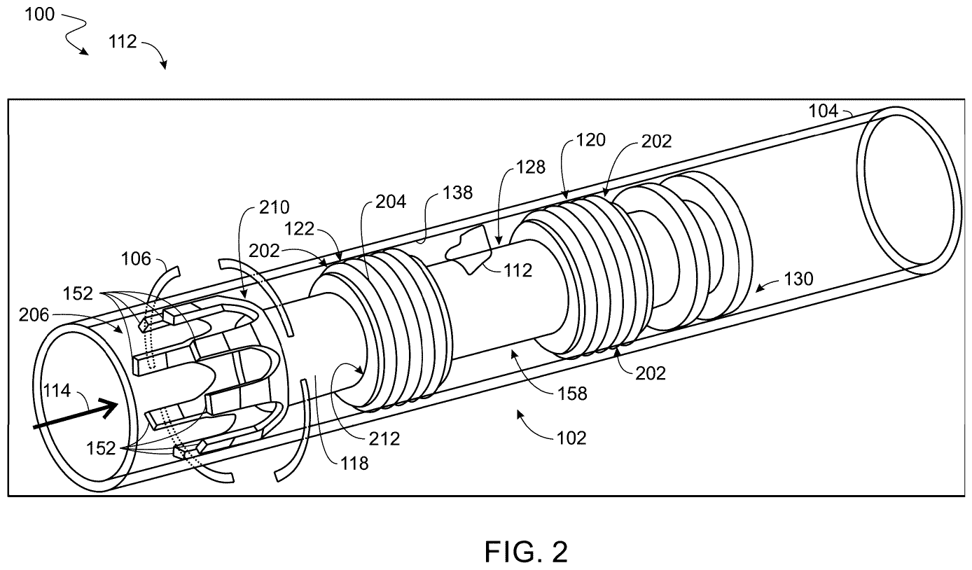

FIG. 1 shows a perspective view of a bypass system 100 for bypassing a portion 102 of a pipeline 104. FIG. 2 shows a perspective view of the bypass system 100 of FIG. 1 actuated to bypass the portion 102 of the pipeline 104. The bypass system 100 includes a bypass assembly 110 positioned in the pipeline 104 and a magnet 106 positioned outside 108 the pipeline 104 near the pipeline 104. The bypass assembly 110 is activated by the magnet 106 to seal the portion 102 of the pipeline 104 and fluidly bypass the portion 102 of the pipeline 104 to allow for continued operation of the pipeline 104. The bypass assembly 110 has three main parts: a bypass cylinder 158, a hollow cylinder 118, and a ferromagnetic tail 126. The ferromagnetic tail 126 is coupled to the hollow cylinder 118 and extends from the second end 132 of the hollow cylinder 118 in the upstream direction 136. The ferromagnetic tail 126 is movable between a first position as shown in FIG. 1 to a second position relative to the bypass cylinder 158 as shown in FIG. 2. When in the second position, the ferromagnetic tail 126 is farther away from the bypass cylinder 158 than when in the first position. The bypass cylinder 158 slides relative to the hollow cylinder 118 between a first position 162 shown in FIG. 1 and a second position 212 shown in FIG. 2. The bypass cylinder moving (sliding) away from the ferromagnetic tail 126 from the first position 162 to the second position 212 actuates the bypass cylinder 158 to seal against the pipeline 104 as described in more detail in reference to FIGS. 1-5C.

The pipeline 104 has a rupture 112. The rupture 112 is in the portion 102 of the pipeline 104. Fluid flows through the pipeline 104 in a downstream direction 114. As fluid contained within the pipeline 104 flows through the pipeline 104 past the rupture in the downstream direction 114, some fluid flows through the rupture 112 out the pipeline 104. Leaking fluid can contaminate the environment outside 108 the pipeline 104 or harm personnel in the vicinity of the leak 116. The rupture 112 can be any break, crack, hole, fracture, separation, stuck open valve, or any other manner of allowing fluid to unintentionally escape from the pipeline 104. The bypass assembly 110 is propelled through the pipeline 104 in the downstream direction 114 by the fluid flow to the location of the portion 102 of the pipeline 104 having the rupture 112. The rupture 112 has a major dimension 160. In this implementation, the major dimension is a length. However, in other implementations, the major dimension can be a diameter.

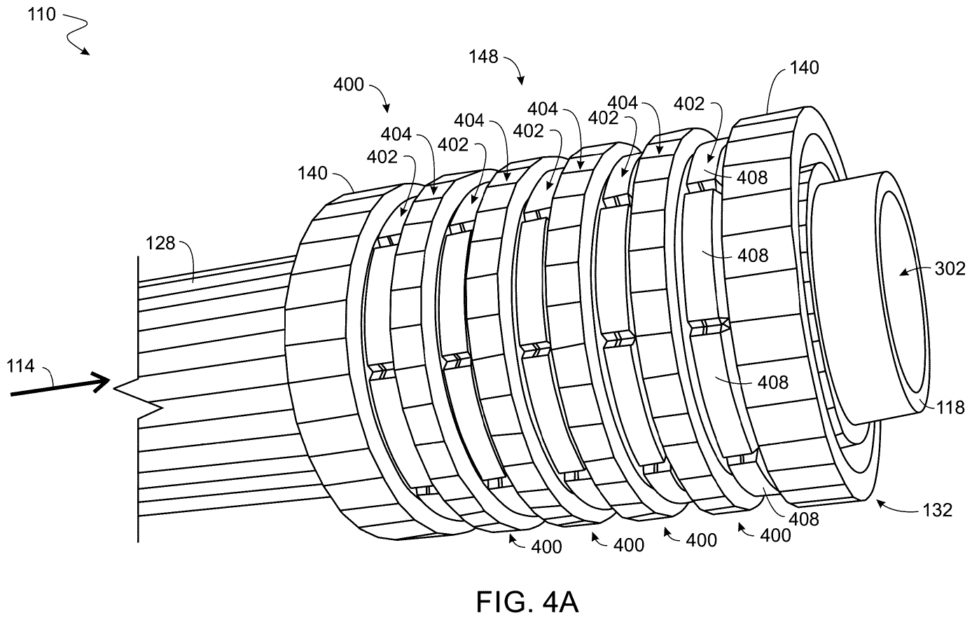

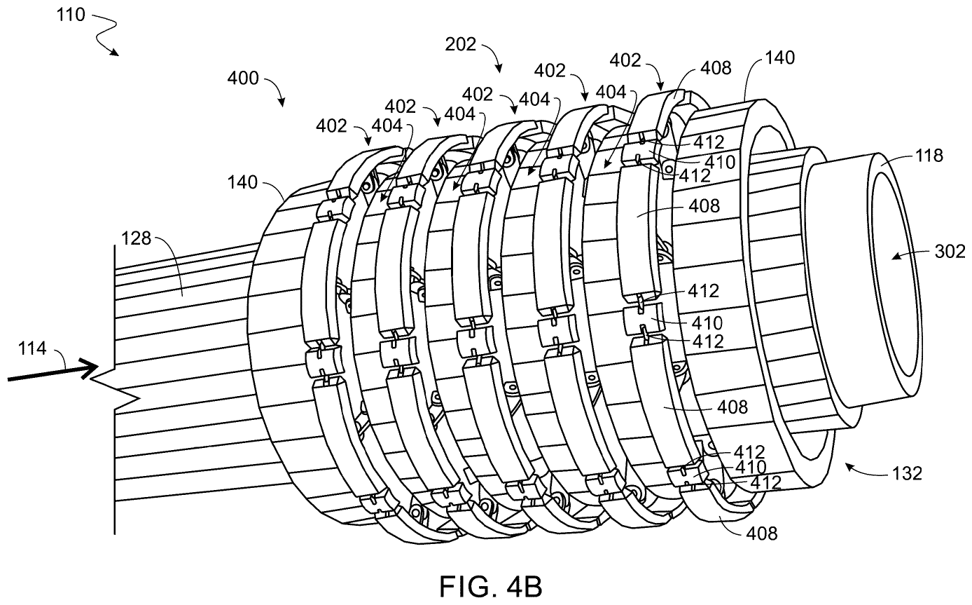

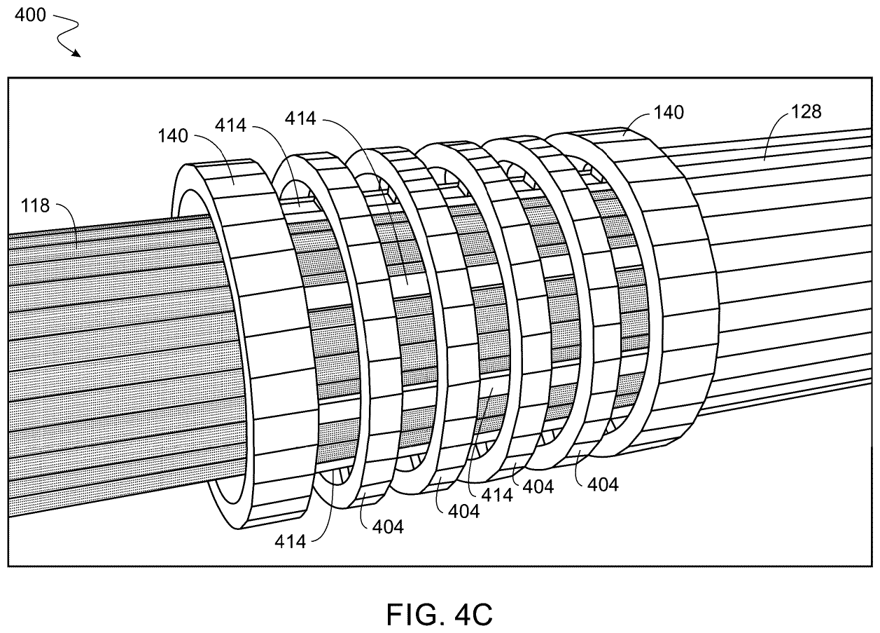

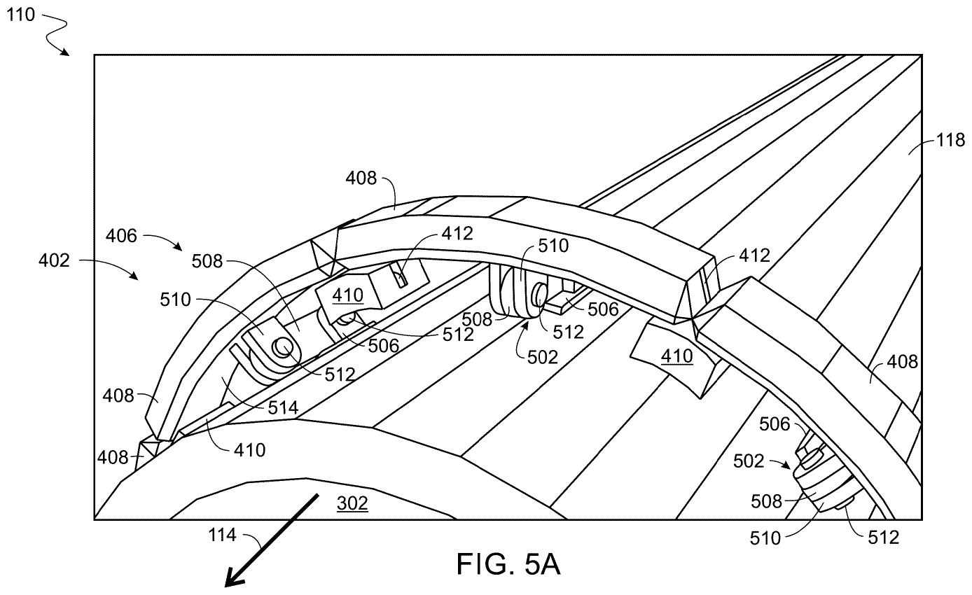

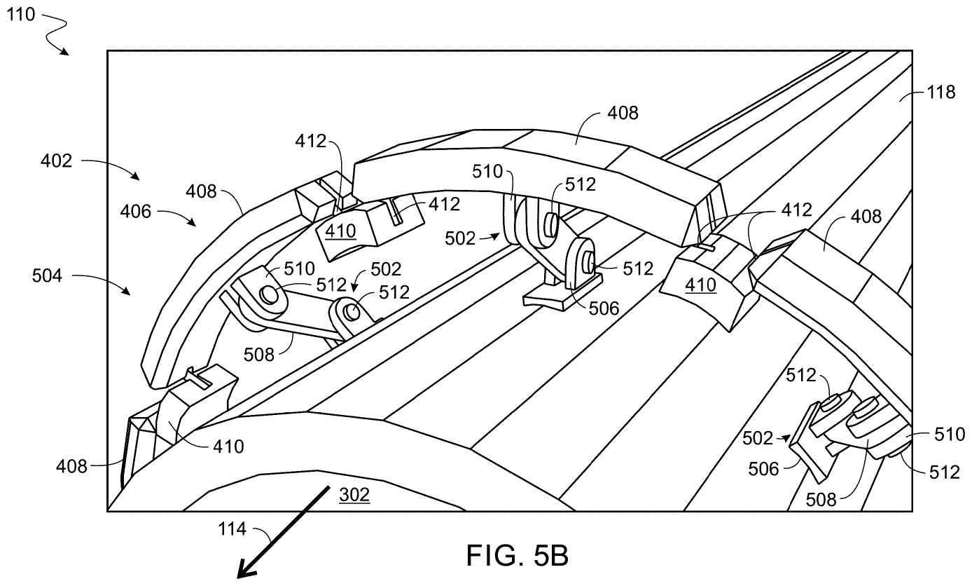

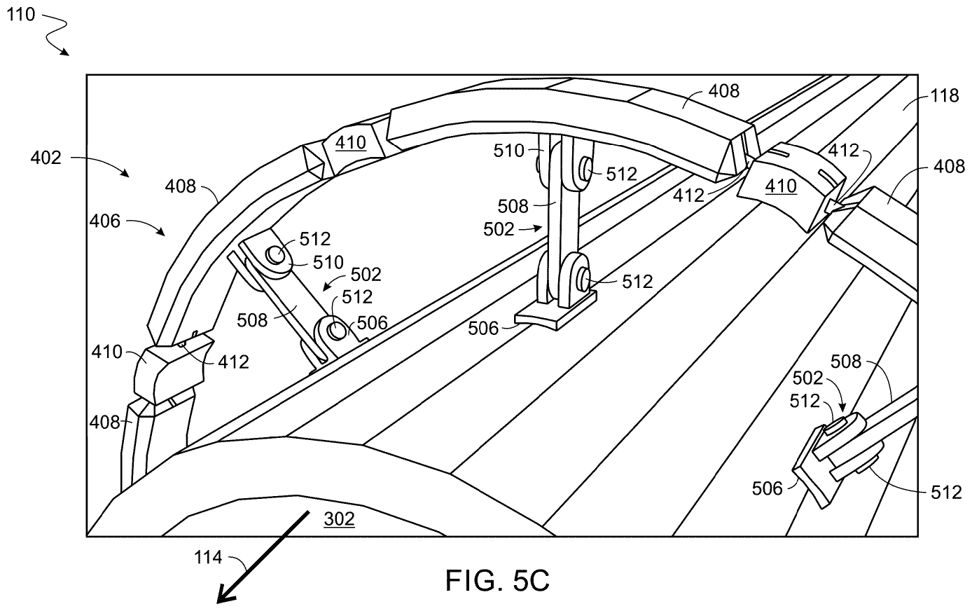

Referring to FIGS. 1-2, the bypass cylinder 158 of the bypass assembly 110 includes an expansion tube 128 positioned about the hollow cylinder 118, a first expansion ring sub-assembly 120 and a second expansion ring sub-assembly 122 mounted on to an outer surface 124 the expansion tube 128. The expansion tube 128 is held by friction and/or mechanical features such as detents in the first position 162 between the hollow cylinder 118 and the expansion tube 128. The ferromagnetic tail 126 extends from the hollow cylinder 118. The magnet 106 holds the ferromagnetic tail 126 in place in the pipeline 104 when the ferromagnetic tail 126 is in the presence of the magnet 106. Fluid flows through the pipeline 104 moving the bypass cylinder 158 away from the ferromagnetic tail 126 to seal the bypass cylinder 158 to the pipeline 104. The fluid force pushing the expansion tube 128 away from the ferromagnetic tail 126 overcomes the friction and/or mechanical features and the expansion tube 128 moves along the hollow cylinder 118 away from the ferromagnetic tail 126, causing the first expansion ring sub-assembly 120 and the second expansion ring sub-assembly 122 to expand from the expansion tube 128 and seal against the pipeline 104 as described in more detail in FIGS. 4A-5C. The first expansion ring sub-assembly 120 and the second expansion ring sub-assembly 122 expand to contact and seal against an inner surface 138 of the pipeline 104, isolating the portion 102 of the pipeline 104 with the rupture 112. The hollow cylinder 118 conducts fluid through the bypass assembly 110.

The hollow cylinder 118 has a first end 130 and a second end 132. The second end 132 is the opposite end from the first end 130. In use, when the user deploys the bypass assembly 110 in the pipeline 104, the first end 130 faces toward a downstream end 134 of the pipeline 104 and the second end 132 faces toward an upstream end 136 of the pipeline 104.

The expansion tube 128 is coupled to the hollow cylinder 118 by tracks. The expansion tube 128 slides relative to the hollow cylinder 118 along the tracks. The length of the tracks can be limited to the movement needed to move the first expansion ring sub-assembly 120 and the second expansion ring sub-assembly 122 from the stored position 148 to the extended position 202. The tracks can include stops to limit the extent of the movement of the expansion tube 128 relative to the hollow cylinder 118. The tracks can include gears and linkages to extend and retract the first expansion ring sub-assembly 120 and the second expansion ring sub-assembly 122 to engage the pipeline 104.

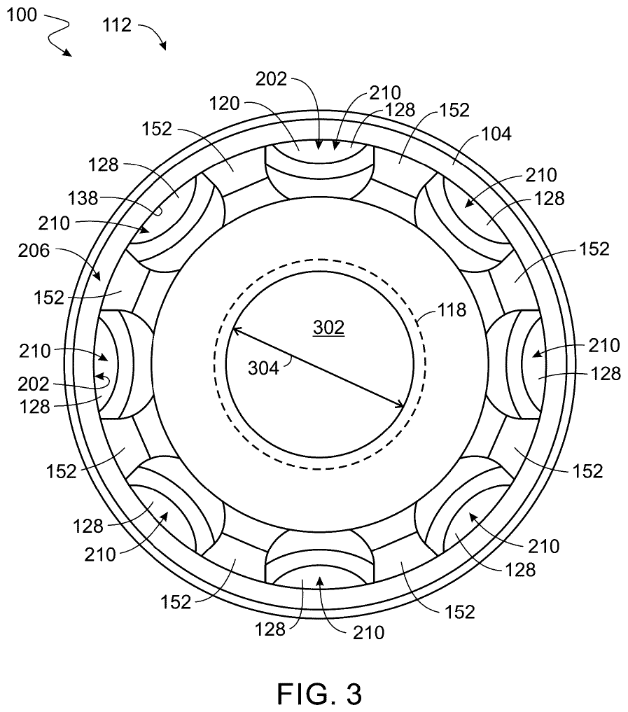

FIG. 3 is rear view of the bypass system 100 of FIG. 2 actuated to bypass the portion 102 of the pipeline 104. Referring to FIGS. 2-3, when in the presence of the magnetic field, the bypass assembly 110 is located at a position inside the pipeline 104 to seal and bypass the rupture 112 in the pipeline 104.

The hollow cylinder 118 defines a bypass channel 302 (shown in FIG. 3). The bypass channel 302 extends from the first end 130 to the second end 132 of the hollow cylinder 118. The bypass channel 302 conducts fluid from the second end second end 132 to the first end 130 of the hollow cylinder 118.

In use, when the user deploys the bypass assembly 110 into the pipeline 104 and the magnet 106 upstream from the rupture 112. The influence of the magnet 106 holds the bypass assembly 110 at the portion 102 in the pipeline 104 with the first expansion ring sub-assembly 120 downstream 134 of the rupture 112 and the second expansion ring sub-assembly 122 upstream from the rupture 112. The first expansion ring sub-assembly 120 and the second expansion ring sub-assembly 122 expand to seal to the inner surface 138 of the pipeline 104. The rupture 112 is bypassed by the fluid in the pipeline 104 being forced into and through the bypass channel 302 from the second end 132 to the first end 130.

Referring to FIG. 3, the bypass channel 302 is defined by an inner diameter 304. The inner diameter 304 can depend on the pipeline diameter. In some implementations, the outer diameter of the non-actuated bypass assembly 110 is less than an inner diameter of the pipeline 104. For example, the outer diameter of the non-actuated bypass assembly can be between 90% 99% of the inner diameter of the pipeline 104. The outer diameter of the actuated bypass assembly equals the inner diameter of the pipeline 104 to ensure sealing. The inner diameter 304 of the bypass channel 302 is determined by ensuring less than the outer diameter of the bypass assembly 110 including the expansion ring sub-assemblies 120, 122 in the extended position 202.

Referring to FIGS. 1 and 2, the hollow cylinder 118 has a length 144. The length 144 can be approximately two times the outer diameter of the actuated bypass assembly 110. But using one or more flexible joints 208 can increase the length range to more than five times. The bypass assembly 110 to be deployed can be configured to the necessary length to isolate and bypass the rupture 112 depending on the rupture 112 characteristics and leak 116 parameters.

When multiple bypass assemblies 110 are pre-positioned in the pipeline 104, a particular bypass assembly 110 having a hollow cylinder 118 with a suitable length 144 can be selected based on leak 116 or rupture 112 parameters to seal the rupture 112. The length 144 of the hollow cylinder 118 is large enough to allow for positioning of the first expansion ring sub-assembly 120 on the outer surface 124 at toward the first end 130 and the second expansion ring sub-assembly 122 at the second end 132 of the hollow cylinder 118 respectively, downstream 134 and upstream 136 of the rupture 112 so the rupture 112 can be isolated.

The bypass assembly 110 has at least one disc 140 coupled to the hollow cylinder 118. The disc 140 extends from the outer surface 124 of the hollow cylinder 118. The discs 140 can be at distinct positions along the length 144 of the hollow cylinder 118. The discs 140 receive the fluid flowing through the pipeline 104. As the fluid in the pipeline 104 impinges on the discs 140, a motive force is imparted upon the bypass assembly 110 and the bypass assembly 110 moves through the pipeline 104 in the downstream direction 114. In this implementation, the discs 140 are solid. In other implementations, the discs 140 can be hollow. Some of the 140 discs are fixed to the outer surface 124 of the hollow cylinder 118. In some implementations, some discs 140 are part of a single body including the hollow cylinder 118.

In this implementation, some discs 140, such as the disc 140 proximal the first expansion ring sub-assembly 120 and disc 140 proximal the second expansion ring sub-assembly 122 are coupled to the expansion tube 128. These discs 140 may move along the outer surface 124 of the hollow cylinder 118 with the expansion tube 128, as described in reference to FIGS. 4A-4B and 5A-5C. These discs 140 help the expansion tube 128 move along and slide relative to the hollow cylinder to act on extension arms 508 to aid in the force moving first expansion ring sub-assembly 120 and the second expansion ring sub-assembly 122 to the extended position 202.

The discs 140 extend from the outer surface 124 of the hollow cylinder 118 by a height 142. The discs 140 can all have the same height 142, or the heights 142 can be different. The height 142 of the discs 140 can be equal to the height of the non-actuated first expansion ring sub-assembly 120 and the second expansion ring sub-assembly 122 while ensuring enough surface area is available to adequately contact the flow of fluids in the pipeline 104 to facilitate movement of the bypass assembly 110 within the pipeline 104. In some implementations, the height 142 can be between 5-40% of the total height of the bypass assembly 110. The height 142 of the discs 140 can be selected based on the parameters within the pipeline 104 particularly the fluid flow velocity.

In this implementation, two discs 140 are positioned at the second end 132 of the hollow cylinder 118. Two additional discs 140 are positioned about the first expansion ring sub-assembly 120. Two more discs 140 are positioned about the second expansion ring sub-assembly 122 at the second end 132. But in other implementations, any suitable number and positioning of discs 140 may be used.

The first expansion ring sub-assembly 120 and the second expansion ring sub-assembly 122 actuate to expand and contact against the inner surface 138 of the pipeline 104. The first expansion ring sub-assembly 120 and the second expansion ring sub-assembly 122 seal against the inner surface 138 of the pipeline 104 to isolate the portion 102 of the pipeline 104 with the rupture 112. The first expansion ring sub-assembly 120 and the second expansion ring sub-assembly 122 are positioned along the outer surface 124 and spaced apart by a distance 146. The distance 146 is selected so that the first expansion ring sub-assembly 120 and the second expansion ring sub-assembly 122 are spaced apart downstream 134 and upstream 136, respectively, of the rupture 112 so the rupture 112 can be isolated. The distance 146 can be between 20% and 90% of the distance 146.

The expansion ring sub-assemblies 120, 122 are actuatable to expand from the outer surface 124 of the hollow cylinder 118 from a stored position 148 (shown in FIG. 1) to an extended position 202 (shown in FIGS. 2-3) as described in reference to FIGS. 4 and 5. The first and second expansion ring sub-assemblies 120, 122 have an internal pivotable frame structure which moves between the stored position 148 and the extended position 202.

When the expansion ring sub-assemblies 120, 122 are in the stored position 148, the expansion rings 120, 122 are spaced apart from the inner surface 138 of the hollow cylinder 118. When the expansion ring sub-assemblies 120, 122 are in the extended position 202, the expansion rings 120, 122 contact and seal against the inner surface 138 of the hollow cylinder 118, preventing fluid flow through the pipeline 104 outside the bypass assembly 110, and forcing the fluid flow through the bypass channel 302, bypassing the isolated portion 102 of the pipeline 104.

The expansion ring sub-assemblies 120, 122 have an outer surface 204 (shown in FIGS. 1-2). The outer surface 204 can be a high-friction material to further engage the inner surface 138 of the pipeline 104. For example, the outer surface 204 can include mechanical features such as ridges, ribs, or undulations to increase sealing to the inner surface 138 when the inner surface is uneven. For example, the outer surface 204 can be one or more combinations of materials including natural rubber, synthetic rubber, ethylene propylene diene monomer (EPDM), neoprene rubber, nitrile rubber (Buna-N), polyurethane (PU), cork-rubber blends, or graphite-based materials.

The first expansion ring sub-assembly 120 is positioned on the hollow cylinder 118 toward the first end 130 to seal the pipeline 104 downstream of the rupture 112. The second expansion ring sub-assembly 122 is positioned substantially near the second end 132 of the hollow cylinder 118 to seal the pipeline 104 upstream 136 of the rupture 112. In this implementation, two expansion ring sub-assemblies 120, 122 are used. But in other implementations, other suitable numbers or spacings of expansion ring sub-assemblies 120, 122 may be used. For example, a single expansion ring sub-assembly can be used. The single expansion ring sub-assembly can be sized to extend past the outer boundaries of the rupture 112 to seal the entire rupture area. For example, three, four, five, or even more expansion ring sub-assemblies 120, 122 can seal one or multiple ruptures 112.

Returning to the ferromagnetic tail 126, referring to FIGS. 1-3, the ferromagnetic tail 126 is coupled to the second end 132 of the hollow cylinder 118. The ferromagnetic tail 126 extends from the second end 132 of the hollow cylinder 118 The ferromagnetic tail 126 can be fastened, pinned, inserted into, or molded to the hollow cylinder 118.

The ferromagnetic tail 126 bends to contact the inner surface 138 of the pipeline 104 responsive to influence of the magnetic field of the magnet 106. Referring to FIG. 1, the ferromagnetic tail 126 is in a relaxed state 150. When in the ferromagnetic tail 126 is in the relaxed state 150, the ferromagnetic tail 126 may be partially in contact with the inner surface 138 of the pipeline 104, or not in contact with the inner surface 138 of the pipeline 104. The bypass assembly 110 is generally free to traverse the pipeline 104 responsive to fluid flow in the downstream direction 114 unimpeded by the ferromagnetic tail 126. Referring to FIGS. 2-3, the bypass assembly 110 has been propelled through the pipeline 104 by the fluid flow in the downstream direction 114 to the portion 102 of the pipeline 104 to be isolated. When the ferromagnetic tail 126 approaches the magnets 106, the strength of the magnetic field increases above a threshold. The ferromagnetic tail 126 articulates and the ferromagnetic tail 126 contacts the inner surface 138 of the pipeline 104 and remains in place and is held by the magnetic field of the magnets 106 in a fixed state 206. The first expansion ring sub-assembly 120 and the second expansion ring sub-assembly 122 are positioned downstream 134 and upstream 136, respectively, from the rupture 112. Some fluid flow is allowed past the ferromagnetic tail 126 to force the hollow cylinder 118 to continue moving in the downstream direction 114. As the hollow cylinder 118 moves away from the ferromagnetic tail 126 in the downstream direction 114, the expansion tube 128 is released, moving the first expansion ring sub-assembly 120 and the second expansion ring sub-assembly 122 from the stored position 148 to the extended position 202, engaging the first expansion ring sub-assembly 120 and the second expansion ring sub-assembly 122 to the inner surface 138 of the pipeline 104 and sealing the portion 102 of the pipeline 104 downstream 134 and upstream 136 of the rupture 112. When the first expansion ring sub-assembly 120 and the second expansion ring sub-assembly 122 are in the extended position 202, they engage to the inner surface 138 of the pipeline 104 and seal the portion 102 of the pipeline 104 downstream 134 and upstream 136 of the rupture 112.

Referring to FIGS. 1-3, the ferromagnetic tail 126 has multiple ferromagnetic fingers 152. The multiple ferromagnetic fingers 152 bend between the relaxed state 150 and the fixed state 206 responsive to influence from the magnetic field of the magnets 106. The ferromagnetic fingers 152 concaved inward by when not in the presence of the magnetic field form the magnets 106. Even so, the ferromagnetic fingers 152 are flexible, thus when the magnetic force is applied to the ferromagnetic fingers 152, the ferromagnetic fingers 152 articulate outwards toward the magnets 106 in response to the magnetic field attraction. When the magnets 106 are moved away from the pipeline 104, the magnetic field decreases and the ferromagnetic fingers 152 return to the original, relaxed state 150 and concave inward due to the material elasticity of the multiple ferromagnetic fingers 152.

The ferromagnetic fingers 152 included a flexible material 154 and ferromagnetic sheets 156. The ferromagnetic sheets 156 are embedded within the flexible material 154. In this implementation, the flexible material 154 is a polymer, for example, a rubber. The flexible material 154 can be one or more combinations of materials including natural rubber, synthetic rubber, ethylene propylene diene monomer (EPDM), neoprene rubber, nitrile rubber (Buna-N), polyurethane (PU), cork-rubber blends, or graphite-based materials. In some implementations, the rubber is texturized. The multiple ferromagnetic fingers 152 have a length and a thickness. The length and thickness of the multiple ferromagnetic fingers 152 can be selected based on flow conditions in the pipeline 104. For example, if the bypass assembly 110 is being used to isolate and bypass a portion of a pipeline 104 having a higher fluid flow rate, wider or longer ferromagnetic fingers 152, may be used.

The ferromagnetic sheets 156 have a specific permeability. In this implementation, the specific permeability of the ferromagnetic sheets 156 is between 0.001 to 0.01 Henries per meter (H/m). In other implementations, other materials with other suitable specific permeabilities may be used.

Referring to FIGS. 2-3, when the ferromagnetic fingers 152 contact the inner surface 138 of the pipeline 104, fluid can still flow past an area 210 between the multiple ferromagnetic fingers 152 to the hollow cylinder 118. This flow past the ferromagnetic fingers 152 is the fluid that impacts the discs 140, forcing the hollow cylinder 118 away from the fixed ferromagnetic fingers 152 and therefore actuating the expansion tube 128 to expand the first expansion ring sub-assembly 120 and the second expansion ring sub-assembly 122. FIGS. 4A-4C are perspective views illustrating operation of an expansion ring sub-assembly 400 of the bypass assembly 110 of FIG. 1. FIGS. 5A-5C are perspective views illustrating operation of an expansion member 402 of the expansion ring sub-assembly 400 of FIGS. 4A-4C. Each of the first expansion ring sub-assembly 120 are the second expansion ring sub-assembly 122 are an expansion ring sub-assembly 400. FIGS. 4A-4C and 5A-5C are shown and described in reference to the first expansion ring sub-assembly 120. In FIGS. 4A-4C and 5A-5C, the outer surface 204 of the first expansion ring sub-assembly 120 has been removed for clarity.

In FIG. 4A, the expansion ring sub-assembly 400 is in the stored position 148. In FIG. 4B, the expansion ring sub-assembly 400 is in the extended position 202. Referring to FIGS. 1-2 and 4A-4B, the expansion ring sub-assembly 400 includes multiple individual expansion members 402 interspersed with fixed barriers 404. The fixed barriers 404 can include the discs 140.

When the ferromagnetic tail 126 is fixed in place by the magnetic field of the magnets 106, the expansion tube 128, propelled by the fluid impacting the discs 140 coupled to the expansion tube 128, continues to move in the downstream direction 114. After a pre-determined distance and as the expansion tube 128 moves, the first expansion ring sub-assembly 120 and the second expansion ring sub-assembly 122 are mechanically actuated, articulates the expansion members 402 from the stored position 148 to the extended position 202 to contact the expansion ring sub-assembly 400 to the inner surface 138 of the pipeline 104. Removal of the magnets 106 decreases the magnetic field below a threshold value, allowing the ferromagnetic tail 126 to drift, release the expansion members 402 and reengaging the sliding the expansion tube 128 relative to the hollow cylinder 118. One or more springs can pull the hollow cylinder 118 relative to the expansion tube 128 moving the expansion tube 128 back to the first position 162. When the magnetic force is removed, the first expansion ring sub-assembly 120 and the second expansion ring sub-assembly 122 are still in the extended position 202 until the flow acts on the ferromagnetic tail 126 and the expansion tube 128 to move back to the first position 162. As the expansion tube 128 slides back to the first position 162 from the extended position 202, the pivot assemblies 502 articulate to the closed position “non-actuated” which was in open position due to the discs 140 between each expansion ring acting on them. This will disengage the expansion ring sub-assemblies 120, 122 and the bypass assembly 110 is free to move in the pipeline 104 again. The pivot assemblies 502 can include springs to ensure that they will go back to their original positions.

Each expansion member 402 includes a jointed circular arm 406 and a pivot assembly 502 (shown in FIGS. 5A-5C). The jointed circular arm 406 expands and retracts to move the expansion members 402 between the stored position 148 and the extended position 202. The pivot assembly 502 connects the jointed circular arm 406 to the outer surface 204 of the hollow cylinder 118.

The jointed circular arm 406 includes multiple first segments 408, multiple second segments 410, and links 412. Each first segment 408 is separated by a single second segment 410. The links 412 connect each segment 408, 410 to one another. The links 412 are an articulating joint. The links 412 allow the segments 408, 410 to move from a first condition (the stored position 148 of the jointed circular arm 406) where the second segments 410 are positioned interior to the first segments 408 with the first segments 408 contacting one another to a second condition (the extended position 202 of the jointed circular arm 406) where the first segments 408 have moved apart and are spaced apart by the multiple second segments 410.

Referring to FIG. 4C, the expansion ring sub-assembly 400 includes one or more extender arms 414. The extender arms 414 are coupled to each of the expansion members 402. The extender arms 414 can extend along the tracks between the hollow cylinder 118 and the expansion tube 128. The extender arms 414 are coupled to the hollow cylinder 118 and the expansion members 402. The extender arms 414 are fixed on one end to the hollow cylinder 118 and the other end to the expansion members 402. As the expansion tube 128 moves relative to the hollow cylinder 118, the expansion members 402 move to the extended position 202.

Referring to FIGS. 5A-5C, the expansion ring sub-assembly 400 includes the pivot assembly 502. The pivot assembly 502 is coupled on one end to the expansion tube 128 and the other end to the jointed circular arm 406 The pivot assembly 502 articulates responsive to movement of the hollow cylinder 118 in the downstream direction 114 (away from the ferromagnetic tail 126) to move the jointed circular arm 406 between the stored position 148 (shown in FIG. 5A), through an intermediate position 504 (shown in FIG. 5B), to the extended position 202 (shown in FIG. 5C). Movement of the expansion tube 128 toward the hollow cylinder 118 performs the reverse operation of the pivot assembly 502.

Each pivot assembly 502 includes a first pivot bracket 506, an extension arm 508, a second pivot bracket 510, and pins 512. The first pivot bracket 506 is fixed to the outer surface 204 of the expansion tube 128. The second pivot bracket 510 is fixed to an inward facing surface 514 of one of the first segments 408. The extension arm 508 extends between the first pivot bracket 506 and the second pivot bracket 510. The one pin 512 extends through the first pivot bracket 506 and another pin 512 extends through the second pivot bracket 510 and the extension arm 508. The pins 512 rotatably couple the extension arm 508 to the first pivot bracket 506 and the second pivot bracket 510.

Referring to FIG. 2, the bypass assembly 110 can include at least one flexible joint 208. The flexible joint 208 can be coupled any two portions of the of the hollow cylinder 118. The flexible joint 208 allows different portions of the bypass assembly 110 to articulate relative to one another to increase maneuverability and mobility of the bypass assembly 110 as the bypass assembly 110 traverses the pipeline 104. Some pipelines 104 can include bends. By including one or more flexible joints 208, the bypass assembly 110 can move through different arrangements of pipelines 104.

In this implementation, one flexible joint 208 is positioned between two discs 140 near the first end 130 of the hollow cylinder 118. In other implementations, any number and arrangement of flexible joints 208 may allow the bypass assembly 110 to improve movement of the bypass assembly 110 through the pipeline 104.

The flexible joint 208 can be a flexible rubber joint, a flexible metal hose, or both. In this implementation, the flexible joint 208 can be made from one or more combinations of materials including natural rubber, synthetic rubber, ethylene propylene diene monomer (EPDM), neoprene rubber, nitrile rubber (Buna-N), polyurethane (PU), cork-rubber blends, or graphite-based materials. In other implementations, any suitable material may be used.

In some cases, isolating and bypassing the portion 102 of the pipeline 104 can be planned. For example, when maintenance, planned repair, or improvements such as reinforcing, construction, or attaching additional equipment such as other pipeline branches, relief valves, or sensors is desired, the bypass assembly 110 can be placed at the desired location and the pre-planned operations can be conducted safely while fluid continues to flow through the pipeline 104.

Operators monitor pipelines 104 for leaks 116. When the leak 116 is detected from the pipeline 104, the magnets 106 are positioned outside 108 the pipeline 104 near the rupture 112. One or more bypass assemblies 110 can pre-positioned within the pipeline 104 or introduced into the pipeline 104 upstream 136 from the rupture 112. The operator can direct the bypass assembly 110 into the pipeline 104.

As described in reference to FIGS. 1-2, the bypass assembly 110 is propelled through the pipeline 104 in the downstream direction 114 by the fluid flow to the location of the portion 102 of the pipeline 104 having the rupture 112. In other implementations, the bypass assembly 110 can be introduced into the pipeline 104 or movement through the pipeline 104 can be initiated automatically responsive to detecting the leak 116.

Multiple bypass assemblies 110 can be stored at several locations to minimize the response time when a leak 116 is detected. In some implementations, individual bypass assemblies 100 are spaced apart with the pipeline 104 at pre-determined distances from each other.

As shown in FIGS. 1 and 2, the bypass system 100 uses four semi-circular magnets arranged about a circumference of the pipeline 104. In other implementations, other suitable numbers, sizes, or arrangements of magnets 106 may be used. The magnets 106 generate a magnetic field. The magnetic field passes from the magnets 106 into the pipeline 104 to influence the bypass assembly 110. Responsive to influence of the magnetic field, the bypass assembly 110 is held at the location of the rupture and activates to seal the portion 102 of the pipeline 104.

In this implementation, the magnets 106 are electromagnets which can be enabled and disabled by supplying and cutting off/reducing the electrical current supplied to the magnets 106. Alternatively or additionally, the magnets 106 can include a permanent magnet. The magnets 106 are strong enough to influence the bypass assembly 110 within the pipeline 104. Magnets 106 can be selected based temperature of the surrounding environment 108 and/or the pipeline 104. some magnets 106 may be affected by elevated temperatures so the magnetism of the magnet 106 may decrease or a permanent magnet may lose its magnet properties. Sometimes, a magnet switch can be used for enabling and disabling the permanent magnets.

The pulling strength of the magnets 106 can be selected based on several factors. For example, a distance between the magnets 106 and the object to be affected (in this application the object to be affected is the ferromagnetic tail 126). In this implementation, the distance between the magnets 106 and the ferromagnetic tail 126 depends on the diameter of the pipeline 104. Another factor influencing the selection of the magnets 106 is the velocity of the fluid in the pipeline 104. As the velocity of the fluid in the pipeline 104 increases, stronger magnets 106 may be needed to overcome velocity related forces. The viscosity of the fluid in the pipeline 104 can affect the pulling strength of the magnets 106, so the selection of magnets 106 can take into account the resistance of the fluid to flow. Additionally, the magnets 106 can be selected based on the specific permeability of the metallic object to be magnetically influenced.

The magnets 106 can be placed about the pipeline 104 by various means. For example, as described in U.S. patent application Ser. No. 18/344,498 and U.S. patent application Ser. No. 18/501,631, which are incorporated herein by reference, robots, robot systems, or positioners can position and operate magnets exterior to pipelines. Additionally, an unmanned aerial vehicle, an unmanned surface vehicle, an unmanned submersible vehicle, or an unmanned ground vehicle can include magnets 106 and position the magnets 106 outside the pipeline 104 proximal the portion 102 of the pipeline 104 to be isolated and bypassed. The positioning system for the magnets 106 can be manually controlled, remotely controlled, or automatically controlled. In some implementations, a person can place the magnets 106 about the pipeline 104.

In other implementations, a bypass assembly is configured to internally bypass a portion of a pipeline. The bypass assembly includes a body, an expansion tube, a first expansion ring sub-assembly, a second expansion ring sub-assembly, and multiple flexible ferromagnetic fingers. The body defines a bypass channel therethrough. The first expansion ring sub-assembly is coupled to the expansion tube at a first location. The first expansion ring sub-assembly is configured expand relative to the body. The second expansion ring sub-assembly is coupled to the expansion tube at a second location spaced apart from the first location. The second expansion ring sub-assembly is configured to expand relative to the expansion tube. The flexible ferromagnetic fingers are configured to move into contact with the pipeline responsive to a presence of a magnetic field outside the pipeline. Movement of the expansion tube relative to the body operates the first expansion ring sub-assembly and the second expansion ring sub-assembly. The expansion tube initiates expansion of the first expansion ring sub-assembly and the second expansion ring sub-assembly. In this implementation, the expansion tube can be further configured to move the body relative to the flexible ferromagnetic fingers responsive to movement of the flexible ferromagnetic fingers articulating in the magnetic field.

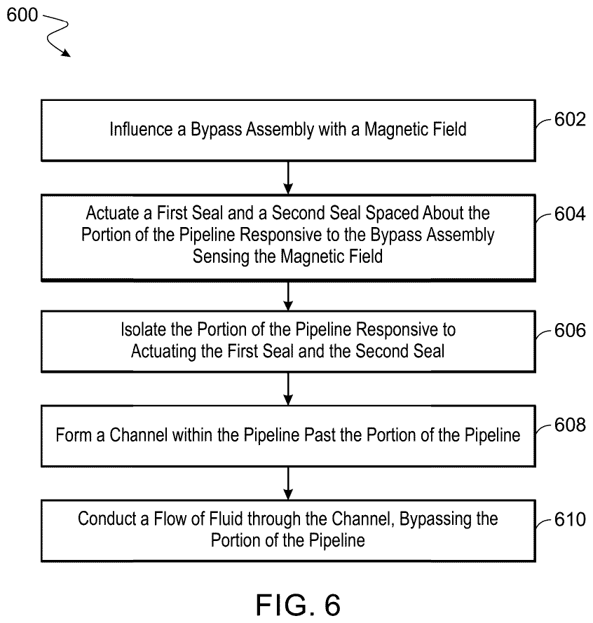

FIG. 6 is a flow chart of an example method of bypassing a portion of a pipeline according to the implementations of the present disclosure. At 602, a magnetic field influences a bypass assembly. For example, referring to FIGS. 1-3, the ferromagnetic tail 126 enters the magnetic field of the magnets 106.

At 604, responsive to influencing the bypass assembly with the magnetic field, a first seal and a second seal spaced about the portion of the pipeline are actuated. For example, referring to FIGS. 1-3, the expansion tube 128 trips as the hollow cylinder 118 moves away from the ferromagnetic tail 126, and the first expansion ring sub-assembly 120 and the second expansion ring sub-assembly 122 move from the stored position 148 to the extended position 202. In some cases, the portion 102 of the pipeline 104 can include the rupture 112.

At 606, responsive to actuating the first seal and the second seal, the portion of the pipeline is isolated. Referring to FIGS. 2-3, the first expansion ring sub-assembly 120 and the second expansion ring sub-assembly 122 have contacted and sealed against the inner surface 138 of the pipeline 104, preventing fluid in the pipeline 104 from reaching the rupture 112.

At 608. a channel is formed within the pipeline past the portion of the pipeline. For example, referring to FIGS. 2-3, the bypass channel 302 of the hollow cylinder 118 is positioned and fixed about the isolated portion 102 of the pipeline 104.

At 610, a flow of fluid is conducted through the channel, bypassing the portion of the pipeline. For example, referring to FIGS. 2-3, fluid in the pipeline 104 is blocked by the first expansion ring sub-assembly 120 and the second expansion ring sub-assembly 122 and into the bypass channel 302. The fluid flows through the bypass channel 302 past the isolated portion 102.

In some implementations, responsive to actuating the seals, bypassing the leak in the pipeline includes internally isolating a leak in the portion of the pipeline. For example, referring to FIGS. 1-2, when the rupture 112 causes the leak 116 and the first expansion ring sub-assembly 120 and the second expansion ring sub-assembly 122 are in the extended position 202 sealing against the inner surface 138 of the pipeline 104, the first expansion ring sub-assembly 120, the second expansion ring sub-assembly 122, and the hollow cylinder 118 form a barrier isolating the portion 102 of the pipeline 104 having the rupture 112. This prevents further fluid from the pipeline 104 from exiting the rupture 112.

In some implementations, before actuating the first seal and the second seal, bypassing the leak in the pipeline includes positioning the first seal and the second seal about the portion of the pipeline responsive to influence of the magnetic field. For example, referring to FIG. 2, as the pipeline 104 fluids push, by impacting the discs 140, the hollow cylinder 118 through the pipeline 104 after the ferromagnetic tail 126 have been actuated to the fixed state 206, the first expansion ring sub-assembly 120 and the second expansion ring sub-assembly 122 move with the expansion tube 128 to align downstream 134 and upstream 136 of the portion 102 of the pipeline 104 to be isolated.

In some implementations, bypassing the leak in the pipeline includes partially isolating, by a flexible magnet, a first portion of a pipeline from a second portion of a pipeline responsive to influence the magnetic field. For example, referring to FIG. 2, when the multiple ferromagnetic fingers 152 have contacted the inner surface 138 of the pipeline 104 because of the presence of the magnetic field of the magnets 103, the area 210 between each of the multiple ferromagnetic fingers 152 is free to pass fluid.

In some implementations, bypassing the leak in the pipeline includes influence a movement of the flexible magnet responsive to the magnetic field; and actuating the first seal and the second seal responsive to influence the movement of the flexible seal. For example, alternatively or in addition, the bypass assembly 110 can include a mechanical linkage extending from the multiple ferromagnetic fingers 152 to the hollow cylinder 118. Responsive to the multiple ferromagnetic fingers 152 actuating in the magnetic field, the expansion tube 128 can slide relative to the hollow cylinder 118, moving the first expansion ring sub-assembly 120 and the second expansion ring sub-assembly 122 to the extended position 202.

In some implementations, bypassing the leak in the pipeline includes responsive to an increase in the flow through the channel responsive to partially isolating the first portion of the pipeline from the second portion of the pipeline; and actuating the first seal and the second seal responsive the pressure buildup through the channel. The pressure buildup due to the flow acting on expansion tube 128 will be acting on the discs 140 to push the expansion tube 128. The speed of the fluid will increase while passing through the bypass channel 302.

For example, the increase in flow can force the discs 140 to pull the hollow cylinder 118 away from the magnetically fixed multiple ferromagnetic fingers 152. Alternatively or in addition, the bypass assembly 110 can include a mechanical or electric sensor which trips responsive to an increase in flow past the multiple ferromagnetic fingers 152, initiating movement of the hollow cylinder 118 and expansion of the first expansion ring sub-assembly 120 and the second expansion ring sub-assembly 122.

In some implementations, bypassing the leak in the pipeline includes fully isolating, by a flexible magnet, a first portion of a pipeline from a second portion of a pipeline responsive to influence of the magnetic field. For example, the ferromagnetic tail 126 can fully seal a circumference of the pipeline 104, forcing all the fluid passing through the pipeline 104 into the bypass channel 302. The increase in flow rate can trip an expansion tube 128, causing the hollow cylinder 118 to move in the downstream direction 114 and causing the first expansion ring sub-assembly 120 and the second expansion ring sub-assembly 122 to move to the extended position 202. In some implementations, the bypass channel 302 is initially blocked, and receives the full diverted fluid flow, forcing the hollow cylinder 118 to move in the downstream direction 114 and initiating expansion of the first expansion ring sub-assembly 120 and the second expansion ring sub-assembly 122.

In some implementations, the bypass assembly 110 can include one or more flow sensors. In some implementations, the flow sensors can detect the flow conditions within the bypass channel 302. The bypass assembly 110 can include a mechanical actuation or controller to actuate the first and second expansion ring sub-assemblies 120, 122 based on the flow level detected by the flow sensors based on the flow condition within the bypass channel 302.

### Embodiments

In an example aspect, a system for bypassing a rupture in a pipeline includes a magnet and a bypass assembly. The magnet can be placed outside the pipeline proximal the rupture. The magnet generates a magnetic field. The bypass assembly can be positioned inside the pipeline to seal and bypass the rupture responsive to the magnetic field. The bypass assembly includes a hollow cylinder, an expansion tube, at least two expansion ring sub-assemblies, and a ferromagnetic tail. The hollow cylinder has a first end and a second end opposite the first end. The hollow cylinder has an outer surface extending between the first end and the second end. The expansion tube is disposed about a portion of the outer surface of the hollow cylinder. The expansion tube is slidable relative to the hollow cylinder between a first position and a second position. The expansion tube has a first end and a second end opposite the first end and an outer surface extending between the first end and the second end. The at least two expansion ring sub-assemblies are coupled to the outer surface of the expansion tube. The at least two expansion ring sub-assemblies expand from the outer surface of the expansion tube from a stored position to an extended position responsive to the expansion tube sliding between the first position and the second position. The ferromagnetic tail extends from the second end of the hollow cylinder. The ferromagnetic tail can articulate to contact an inner surface of the pipeline responsive to the magnetic field of the magnet. Contact of the ferromagnetic tail to the inner surface of the pipeline directs a fluid flow to the expansion tube, moving the expansion tube from the first position to the second position and shifting the at least two expansion ring sub-assemblies to the extended position upstream and downstream of the rupture.

In an example aspect combinable with any other example aspect, the at least two expansion ring sub-assemblies are spaced apart at a distance greater than a length of the rupture.

In an example aspect combinable with any other example aspect, responsive to the at least two expansion ring sub-assemblies moving to the extended position, the at least two expansion ring sub-assemblies seal to the inner surface of the pipeline upstream and downstream of the rupture.

In an example aspect combinable with any other example aspect, the at least two expansion ring sub-assemblies seal against the inner surface of the pipeline.

In an example aspect combinable with any other example aspect, contacting the inner surface of the pipeline with the ferromagnetic tail at least partially prevents fluid flow through the pipeline outside the bypass assembly.

In an example aspect combinable with any other example aspect, the ferromagnetic tail includes multiple ferromagnetic fingers.

In an example aspect combinable with any other example aspect, the ferromagnetic fingers include a flexible material and ferromagnetic sheets embedded with the flexible material.

In an example aspect combinable with any other example aspect, the at least two expansion ring sub-assemblies actuate from the stored position to the extended position responsive to an increase in flow through the hollow cylinder from the first end of the hollow cylinder to the second end of the hollow cylinder.

In an example aspect combinable with any other example aspect, the expansion tube moves relative to the hollow cylinder in a downstream direction responsive to articulation of the ferromagnetic tail.

In an example aspect combinable with any other example aspect, the bypass assembly further includes at least one disc extending from the outer surface of the hollow cylinder.

In an example aspect combinable with any other example aspect, the bypass assembly further includes at least one flexible joint coupled between a first portion of the hollow cylinder and a second portion of the hollow cylinder. The at least one flexible joint allows the first portion of the hollow cylinder to articulate relative to the second portion of the hollow cylinder.

In another example aspect, a method for bypassing a portion of a pipeline includes placing a magnet proximal the portion of the pipeline outside the pipeline; actuating a first seal and a second seal of a bypass assembly within the pipeline responsive to influence of a magnetic field of the magnet, the first seal and the second seal spaced about the portion of the pipeline; isolating the portion of the pipeline responsive to actuating the first seal and the second seal; forming a channel within the pipeline past the portion of the pipeline; and conducting a flow of fluid through the channel, bypassing the portion of the pipeline.

In an example aspect combinable with any other example aspect, bypassing the portion of the pipeline includes responsive to actuating the first seal and the second seal, internally isolating a leak from a rupture in the portion of the pipeline.

In an example aspect combinable with any other example aspect, bypassing the portion of the pipeline includes before actuating the first seal and the second seal, positioning the first seal and the second seal about the portion of the pipeline responsive to influence of the magnetic field.

In an example aspect combinable with any other example aspect, bypassing the portion of the pipeline includes partially isolating, by a flexible magnet of the bypass assembly, a first portion of the pipeline from a second portion of the pipeline responsive to influence of the magnetic field.

In an example aspect combinable with any other example aspect, bypassing the portion of the pipeline includes influencing a movement of the flexible magnet responsive to the magnetic field; and actuating the first seal and the second seal responsive to influencing the movement of the first seal and the second seal.

In an example aspect combinable with any other example aspect, bypassing the portion of the pipeline includes actuating the first seal and the second seal responsive to a pressure buildup in the channel from partially isolating the first portion of the pipeline from the second portion of the pipeline.

In an example aspect combinable with any other example aspect, bypassing the portion of the pipeline includes fully isolating, by a flexible magnet, a first portion of the pipeline from a second portion of the pipeline responsive to influence of the magnetic field.

In another example aspect, a bypass assembly can internally bypass a portion of a pipeline. The bypass assembly includes a body, an expansion tube, a first expansion ring sub-assembly, a second expansion ring sub-assembly, and multiple flexible ferromagnetic fingers. The body defines a bypass channel therethrough. The expansion tube is positioned about the body. The first expansion ring sub-assembly is coupled to the expansion tube at a first location. The first expansion ring sub-assembly expands relative to the expansion tube responsive to movement of the expansion tube relative to the body. The second expansion ring sub-assembly is coupled to the expansion tube at a second location spaced apart from the first location. The second expansion ring sub-assembly expand relative to the expansion tube responsive to movement of the expansion tube relative to the body. The flexible ferromagnetic fingers is coupled to the body. The flexible ferromagnetic fingers move into contact with the pipeline responsive to a presence of a magnetic field outside the pipeline.

In an example aspect combinable with any other example aspect, the expansion tube moves relative to the body responsive to movement of the flexible ferromagnetic fingers in the magnetic field.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

1. A system for bypassing a rupture in a pipeline, the system comprising:
a magnet configured to be placed outside the pipeline proximal the rupture, the magnet generating a magnetic field; and
a bypass assembly configured to be positioned inside the pipeline to seal and bypass the rupture responsive to the magnetic field, the bypass assembly comprising:
a hollow cylinder having a first end and a second end opposite the first end and an outer surface extending between the first end and the second end;
an expansion tube disposed about a portion of the outer surface of the hollow cylinder, the expansion tube slidable relative to the hollow cylinder between a first position and a second position, the expansion tube having a first end and a second end opposite the first end and an outer surface extending between the first end and the second end;
at least two expansion ring sub-assemblies coupled to the outer surface of the expansion tube, the at least two expansion ring sub-assemblies configured to expand from the outer surface of the expansion tube from a stored position to an extended position responsive to the expansion tube sliding between the first position and the second position; and
a ferromagnetic tail extending from the second end of the hollow cylinder, the ferromagnetic tail configured to articulate to contact an inner surface of the pipeline responsive to the magnetic field of the magnet, wherein contact of the ferromagnetic tail to the inner surface of the pipeline directs a fluid flow to the expansion tube, moving the expansion tube from the first position to the second position and shifting the at least two expansion ring sub-assemblies to the extended position upstream and downstream of the rupture.

2. The system of claim 1, wherein the at least two expansion ring sub-assemblies are spaced apart at a distance greater than a length of the rupture.

3. The system of claim 1, wherein responsive to the at least two expansion ring sub-assemblies moving to the extended position, the at least two expansion ring sub-assemblies seal to the inner surface of the pipeline upstream and downstream of the rupture.

4. The system of claim 1, wherein the at least two expansion ring sub-assemblies are configured to seal against the inner surface of the pipeline.

5. The system of claim 1, wherein contacting the inner surface of the pipeline with the ferromagnetic tail at least partially prevents fluid flow through the pipeline outside the bypass assembly.

6. The system of claim 1, wherein the ferromagnetic tail comprises a plurality of ferromagnetic fingers.

7. The system of claim 6, wherein each of the plurality of ferromagnetic fingers comprise:
a flexible material; and
ferromagnetic sheets embedded with the flexible material.

8. The system of claim 1, wherein the at least two expansion ring sub-assemblies actuate from the stored position to the extended position responsive to an increase in flow through the hollow cylinder from the first end of the hollow cylinder to the second end of the hollow cylinder.

9. The system of claim 1, wherein the expansion tube is configured to move relative to the hollow cylinder in a downstream direction responsive to articulation of the ferromagnetic tail.

10. The system of claim 1, further comprising at least one disc extending from the outer surface of the hollow cylinder.

11. The system of claim 1, further comprising at least one flexible joint coupled between a first portion of the hollow cylinder and a second portion of the hollow cylinder, the at least one flexible joint configured to allow the first portion of the hollow cylinder to articulate relative to the second portion of the hollow cylinder.

12. A method for bypassing a portion of a pipeline, the method comprising:
placing a magnet proximal the portion of the pipeline outside the pipeline;
actuating a first seal and a second seal of a bypass assembly within the pipeline responsive to influence of a magnetic field of the magnet, the first seal and the second seal spaced about the portion of the pipeline;
isolating the portion of the pipeline responsive to actuating the first seal and the second seal;
forming a channel within the pipeline past the portion of the pipeline; and
conducting a flow of fluid through the channel, bypassing the portion of the pipeline.

13. The method of claim 12, further comprising responsive to actuating the first seal and the second seal, internally isolating a leak from a rupture in the portion of the pipeline.

14. The method of claim 12, further comprising, before actuating the first seal and the second seal, positioning the first seal and the second seal about the portion of the pipeline responsive to influence of the magnetic field.

15. The method of claim 12, further comprising partially isolating, by a flexible magnet of the bypass assembly, a first portion of the pipeline from a second portion of the pipeline responsive to influence of the magnetic field.

16. The method of claim 15, further comprising:
influencing a movement of the flexible magnet responsive to the magnetic field; and
actuating the first seal and the second seal responsive to influencing the movement of the first seal and the second seal.

17. The method of claim 15, further comprising:
actuating the first seal and the second seal responsive to a pressure buildup in the channel from partially isolating the first portion of the pipeline from the second portion of the pipeline.

18. The method of claim 12, further comprising fully isolating, by a flexible magnet, a first portion of the pipeline from a second portion of the pipeline responsive to influence of the magnetic field.

19. A bypass assembly configured to internally bypass a portion of a pipeline, the bypass assembly comprising:
a body defining a bypass channel therethrough;
an expansion tube positioned about the body;
a first expansion ring sub-assembly coupled to the expansion tube at a first location, the first expansion ring sub-assembly configured expand relative to the expansion tube responsive to movement of the expansion tube relative to the body;
a second expansion ring sub-assembly coupled to the expansion tube at a second location spaced apart from the first location, the second expansion ring sub-assembly configured to expand relative to the expansion tube responsive to movement of the expansion tube relative to the body; and
a plurality of flexible ferromagnetic fingers coupled to the body, the plurality of flexible ferromagnetic fingers configured to move into contact with the pipeline responsive to a presence of a magnetic field outside the pipeline.

20. The bypass assembly of claim 19, wherein the expansion tube is further configured to move relative to the body responsive to movement of the plurality of flexible ferromagnetic fingers in the magnetic field.
